(19) United States
(12) Patent Application Publication
(10) Pub. No.: US 2009/0006619 A1
(43) Pub. Date: Jan. 1, 2009

(54) Directory Snapshot Browser

(75) Inventors: Admed H. Mohammed, Redmond, WA (US); Binil K. Kurian, Bellevue, WA (US); Dmitri Gavrilov, Redmond, WA (US); Elbio Renato T. Abib, Redmond, WA (US); Stephanie Cheung, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/771,748

(22) Filed: Jun. 29, 2007

(51) Int. Cl. G06F 15/173; G06F 12/00

(52) U.S. Cl. 709/225; 707/204; 707/E17.005

(57) ABSTRACT

Embodiments of the systems and methods expose a form of backup data, referred to as snapshot data, to an online server. The snapshot data is copy of the directory system at a time in the past. The snapshot data, in embodiments, is exposed as an LDAP server database, which can be manipulated by one or more tools. Thus, the snapshot data is available to online servers to view, to compare, to restore, or to accomplish other actions on the data within the snapshot without server downtime.

### BACKGROUND

Networks are generally configured as a group of servers, clients, and/or other systems, Data, software programs, and/or other information are stored on the network in a physical configuration. However, the information stored on the network is generally stored using a logical system referred to as a directory system, which may or may not have any relation to the physical configuration of the network. Directory systems are generally configured as a directory of servers, domains, folders, and/or files that describe the logical organization of the data stored on a system(s). The directory service can have a predetermined but alterable configuration. A user may alter the configuration by deleting an object in the directory service. However, once an object is deleted, generally, it is difficult to restore the object. A user often must bring down the directory system and restore a backup of the directory service. This restore process causes significant server downtime and takes a great deal of time because rebooting the server(s) is time-consuming.

### SUMMARY

In embodiments, a form of backup data, referred to as snapshot data, is exposed for use without bringing down the directory system. The snapshot data provides a “snapshot” or copy of the directory system at a time in the past. In embodiments, the snapshot data is exposed as a database, for example, an LDAP server. The exposed snapshot data, in the form of a database, is manipulated by one or more tools, for example, an LDAP client. Thus, the snapshot data is available to clients to view, to compare, to restore, or to accomplish other actions on the snapshot data without restoring a backup, which would incur server downtime.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an embodiment of a server network described by a snapshot.

FIG. 2 is a block diagram of an embodiment of a system for manipulating snapshot data on an online server.

FIG. 3 is a block diagram of an embodiment of a method for manipulating snapshot data.

FIG. 4 is a flow diagram of an embodiment of a process for manipulating snapshot data.

FIG. 5 is a flow diagram of an embodiment of a process for viewing snapshot data.

FIG. 6 is a flow diagram of an embodiment of a process for comparing snapshot data.

FIG. 7 is a flow diagram of an embodiment of a process for restoring snapshot data.

FIG. 8 is a block diagram of an embodiment of a computing system operable for manipulating snapshot data.

### DETAILED DESCRIPTION

This disclosure will now more fully describe some embodiments with reference to the accompanying drawings, in which only some of the possible embodiments are shown. Other aspects may be embodied in many different forms and should not be construed as limited to the embodiments set forth herein. Rather, these embodiments are provided so that this disclosure will convey the scope of the possible embodiments to those skilled in the art.

Embodiments of the present invention generally relate to new and improved systems and methods for determining changes to a server network. In embodiments, server network changes are recorded in one or more snapshots. The snapshot can be discovered, that is, a user can locate the one or more snapshots. Once discovered, the snapshots may be mounted. An interface, in embodiments, exposes the snapshot as database data, which can be manipulated similar to the directory service data. As database data, the snapshot data, in embodiments, is interpreted for and accessed by the user through one or more other interfaces.

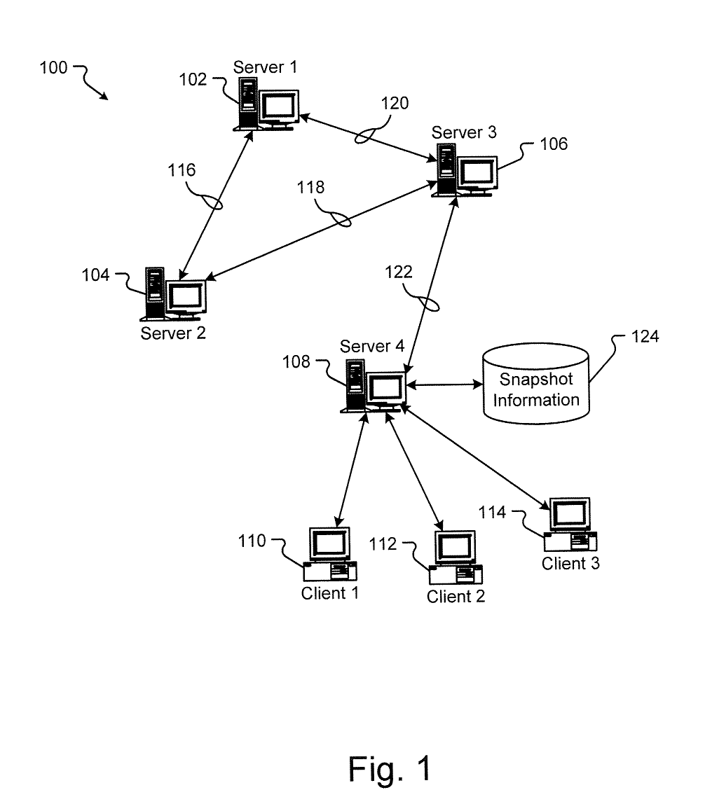

An embodiment of a network 100 is shown in FIG. 1. The network 100 may consist of two or more servers, such as Server 1 102, Server 2 104, Server 3 106, and Server 4 108. It should be noted that a network may contain more or fewer servers or other components, for example, printers, other peripherals, routers, etc. Each server may have one or more client computer systems that communicate with the server. For example, Server 4 108 communicates with or interfaces with Client 1 110, Client 2 112, and Client 3 114. In embodiments, a client application may reside on the server. It should be noted that any one server may communicate with more or fewer clients than shown in FIG. 1.

The servers in the server network 100, in embodiments, are in communication with each other via various “connections,” for example, connections 116, 118, 120, and 122. The term connected or connections is meant to embody any form of communication between two computer systems, which may include, but is not limited to, wireless communication, wired communication, communication over a network, an intranet, the Internet, etc. The communication may be by any protocol or in any form and may occur on a single server or multiple servers and/or clients.

The connections 116, 118, 120, and 122 and the configuration of the connections 116, 118, 120, and 122 defines the configuration of the network. A directory system may be used to describe the logical organization and relationships between data, software, or other information stored across the server network 100. The directory system may interrelate or function to provide data, programs, or other functions to clients. A directory system may be any type of system that controls communications and logical organization of the directories. The directory system may be an object-oriented software system comprising one or more objects, each object with one or more attributes, which control certain aspects of the directory, e.g., replication, connection configuration, etc. In embodiments, the logical organization of the directory system is governed by a directory service, for example, Microsoft's® Active Directory Domain Services.

In embodiments, a user, operating a client computer (e.g., Client 1 110), or a third-party software package installed in the directory system can change the directory system. Changes to the directory system of the network 100 may affect the contents of the directory. In embodiments, changes made by the user or third-party software to the directory system may delete a directory system object. Users often err and wish to restore objects that have been deleted from directory system.

Snapshots are copies of the directory created at predetermined times in the past and stored. In an embodiment, the snapshots are stored in a snapshot datastore 210. Snapshots, in embodiments, are not available to online servers but must be mounted and used for restoration of a network on offline servers. In other embodiments, the snapshots are pre-mounted and available.

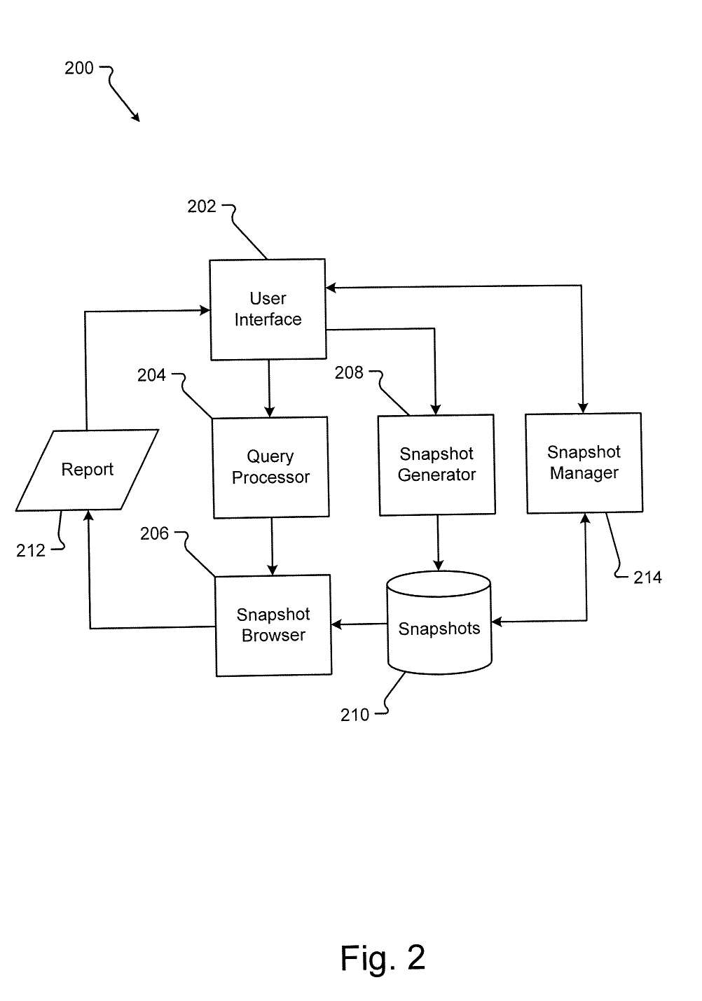

An embodiment of a system 200 to investigate changes to a directory configuration is shown in FIG. 2. The system 200 may comprise, but is not limited to, a user interface 202, a query processor 204, a snapshot generator 208, and a snapshot browser 206, which, in embodiments, is a lightweight directory access protocol (LDAP) server. LDAP is a protocol for accessing directory information in a database system. In embodiments, the system 200 accesses a snapshot data datastore 210. The system 200 may execute at a client, for example, Client 1 110 (FIG. 1), at a server, for example, Server 4 108, or partially at a server and partially at a client. The components of the system 200, in embodiments, are software components or modules executable in a computer system. In alternative embodiments, the components of the system 200 are hardware components or logic gates specially designed to execute the functions described herein.

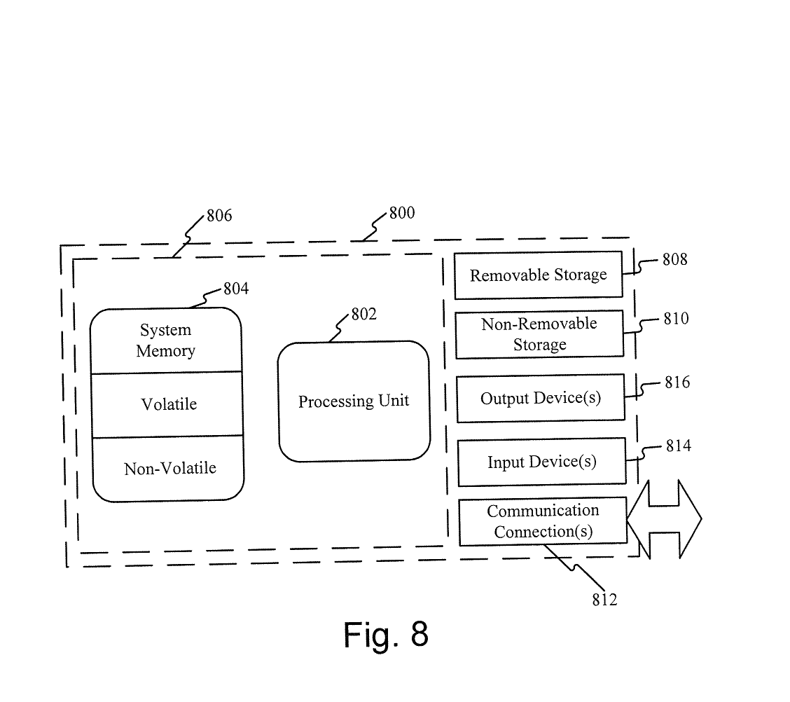

The user interface 202, in embodiments, accepts user selections and provides output for display to the user. User selection devices, input devices, and output devices are described in conjunction with FIG. 8. In embodiments, the user interface 202 comprises one or more tools that allow a user to interact, for example, by accepting changes to the directory configuration, to the snapshot data. Further, the user interface 202 may receive requests to create a snapshot of the directory system. A snapshot is a data structure that describes the directory system at a point in time. The user interface 202 may also receive queries from the user regarding the changes that have been made to the directory system. Snapshot data may be for an entire system and may not be present at the local client. As such, the user interface 202 may discover, i.e., make available to the user, the snapshot data from the local client, other clients, or servers. Once the user mounts the snapshot data, the user interface 202 can provide a view of the exposed snapshot data. In still other embodiments, the user interface 202 provides an output displaying the changes that have been made to the directory system. The user interface 202 is in communication with a query processor 204.

The query processor 204 receives and processes the user interface 202 selections. The query processor 204 may receive a request to determine changes that have been made to the directory system. The query processor 204 can format a query and access the required data to respond to the query. In one embodiment, the query processor 204 communicates with the snapshot browser 206 to retrieve database data to respond to the query. The information retrieved from the snapshot datastore 210 is a snapshot file that is not accessible normally with an online server. As such, the snapshot browser 206 performs, in embodiments, a data conversion to allow the snapshot to be accessible by an LDAP server, and, in further embodiments, by one or more other tools in communication with the query processor 204. In an alternative embodiment, the snapshot browser allows the snapshot database to be accessible via an LDAP server without a data conversion. For example, in Microsoft's Active Directory, the DSAMain.exe snapshot browser allows the snapshot to be accessible from an LDAP server.

The query processor 204, in embodiments, receives and formats the information from the snapshot browser 206 to provide to the user interface 202. In other embodiments, the query processor 204 communicates with the snapshot browser 206 to provide a report of the snapshot 212 to the user interface 202. The report 212 can include viewable information about the snapshot. The snapshot browser 206, in embodiments, is an LDAP server. In alternative embodiments, the snapshot browser 206 is read only, that is, a user cannot make changes to the data in the snapshot.

In one embodiment, a snapshot generator 208 receives instructions from the user interface 202 to create a snapshot and store the snapshot in the snapshot datastore 21 0. The instruction may require the snapshot generator 208 to generate a snapshot immediately following the request. In other embodiments, the user instructs the snapshot generator 208 to generate continuously a snapshot at a predetermined interval, for example, every week.

The snapshot can be mounted and loaded into a LDAP server. The user can then review or use the snapshot while the server remains online and active. In an alternative embodiment, the user manipulates or changes the snapshot data. Further, the user can execute functions on the snapshot data, for example, searches, copies, etc. A snapshot, in embodiments, is also mountable from another server system. By mounting the snapshot, a user need not have server downtime to view older versions of the directory system including deleted objects that the user wishes to restore.

In embodiments, a user interface 202 also communicates with a snapshot manager 214. The snapshot manager 214 may provide the discovery of the snapshots. The snapshot datastore 210, in embodiments, has one or more snapshots stored at different locations, i.e., a remote server. For example, the snapshots may be stored on one or more remote domain controllers. The snapshot manager 214 can determine the location of the snapshots at the remote domain controllers and retrieve information about the snapshots if necessary. In embodiments, each snapshot is associated with snapshot location information, which can be used to determine the location of the snapshot data for a snapshot. Snapshot location information may include, for example, a machine name hosting the snapshot data and LDAP server, and a port number that the LDAP server uses for listening. Accordingly, in embodiments, the snapshot manager discovers snapshots by connecting to a remote domain controller, enumerating a set of snapshots, and retrieving snapshot location information for each of the enumerated snapshots. The snapshot location information can be used for retrieving snapshot data. It should be noted that in some embodiments instead of retrieving data for the entire snapshot, the snapshot manager 214 retrieves snapshot data for user-defined portions of the snapshot. For example, the user may desire to retrieve data for a domain controller (a server that manages the server directory data), for an application partition, for a domain, or other portion of the directory.

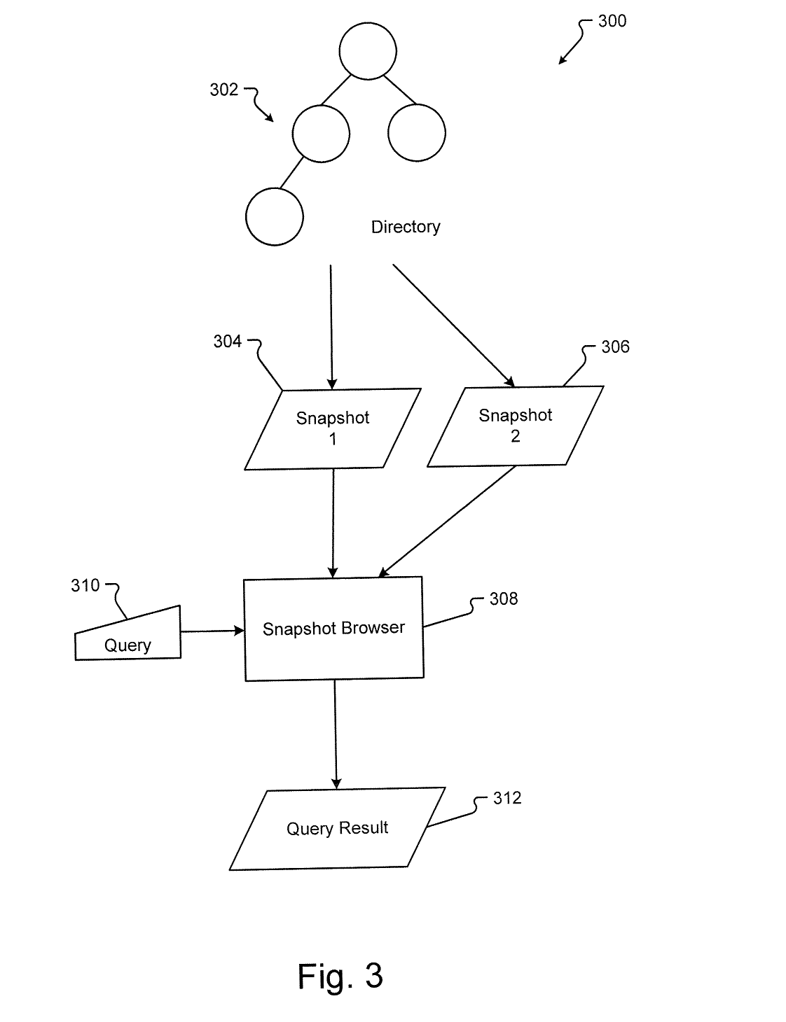

A block diagram showing a process 300 for providing snapshot changes is shown in FIG. 3. A directory 302 is represented by a first snapshot, Snapshot 1 304, taken at a first time, and a second snapshot, Snapshot 2 306, taken at a second time. The directory 302 may be a directory that was changed between the first time and the second time. For example, one or more objects in the directory 302 may have been deleted between the first time and the second time. In embodiments, the snapshots 304 and 306 are complete snapshots. In alternative embodiments, the snapshots 304 and 306 are portions of the entire snapshots. Further, there may be more than two snapshots accessed and exposed.

A snapshot browser 308 mounts Snapshot 1 304 and/or Snapshot 2 306 to be accessible by a database server, for example, a LDAP server. The snapshot browser 308 provides the snapshots 304 and 306 without bringing down the server. As such, the user can view the information in the snapshots 304 and 306 while the server is online and active.

In embodiments, the snapshot browser 308 receives a query 310 from a user. The query 310 may be one of several actions. For example, the query 310 may be to search for an object having a predetermined ID or name. The requested object may have been deleted in the live directory. The snapshot browser 308 may access Snapshot 1 304 to search for the object. Other queries 310 may include, but are not limited to, comparing Snapshot 1 304 and Snapshot 2 306, restoring an object from a snapshot, or displaying a deleted object in the snapshot. The snapshot browser 308 provides a query result 312 to the user.

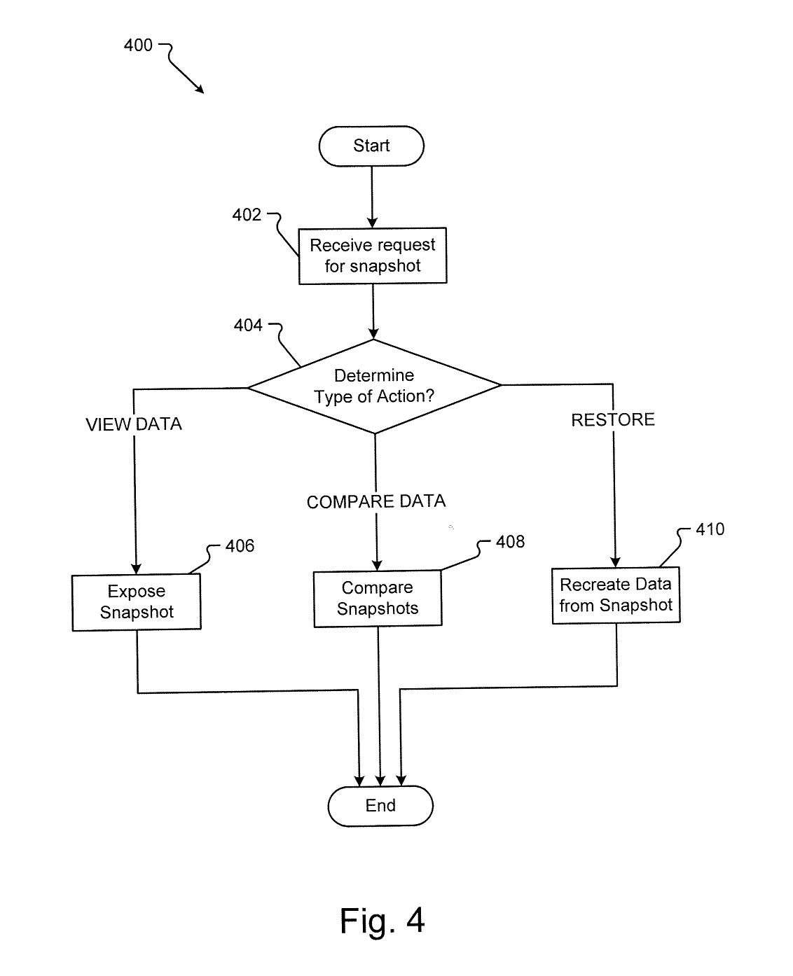

An embodiment of a method 400 for providing a snapshot for one or more purposes is shown in FIG. 4. In embodiments, the method 400 is a set of computer instructions executed in a computer system. The method 400 generally starts with a “Start” operation and ends with an “End” operation.

Receive operation 402 receives a request for snapshot data. In one embodiment, a system 200 (FIG. 2) receives a request from a user for snapshot data from a snapshot datastore 210 (FIG. 2). The request may be received from a user interface 202 (FIG. 2).

Determine operation 404 determines what type of action is to be performed. As explained in conjunction with FIG. 3, the user may perform many functions on the snapshot data. If the action is to view the data in the snapshot, the process flows along the path titled VIEW DATA to expose operation 406. If the action is to compare snapshot data, the process flows along the path titled COMPARE DATA to compare operation 408. If the action is to restore data from a snapshot, the process flows along the path titled RESTORE to recreate operation.

Expose operation 406 exposes the snapshot data. In one embodiment, the snapshot data is converted into database information. An LDAP server or other system reads the snapshot data. The data is changed into database elements similar to the directory system database. In one embodiment, the snapshot is converted into a format similar to Microsoft® Active Directory database data. The snapshot data may then be accessed by one or more tools using LDAP similar to the Active Directory data.

Compare operation 408 compares two or more snapshots. In an embodiment, two or more snapshots are converted into directory data as explained with the expose operation 406. The two or more snapshot database may then be compared. For example, a user may try to determine if an object in a first snapshot exists in a second snapshot. As such, the user may determine the best snapshot to use for restoring the object.

Restore operation 410 restores data from one or more snapshots. The system 200 (FIG. 2), in embodiments, finds a deleted object in the snapshot database. Instead of restoring the entire directory, the deleted object from the snapshot database is copied to the active directory database. As such, the restoration of objects occurs without the need for bringing down the server and restoring all the data from the snapshot. One or more objects or other portions of data may be restored from the snapshot database in a similar fashion.

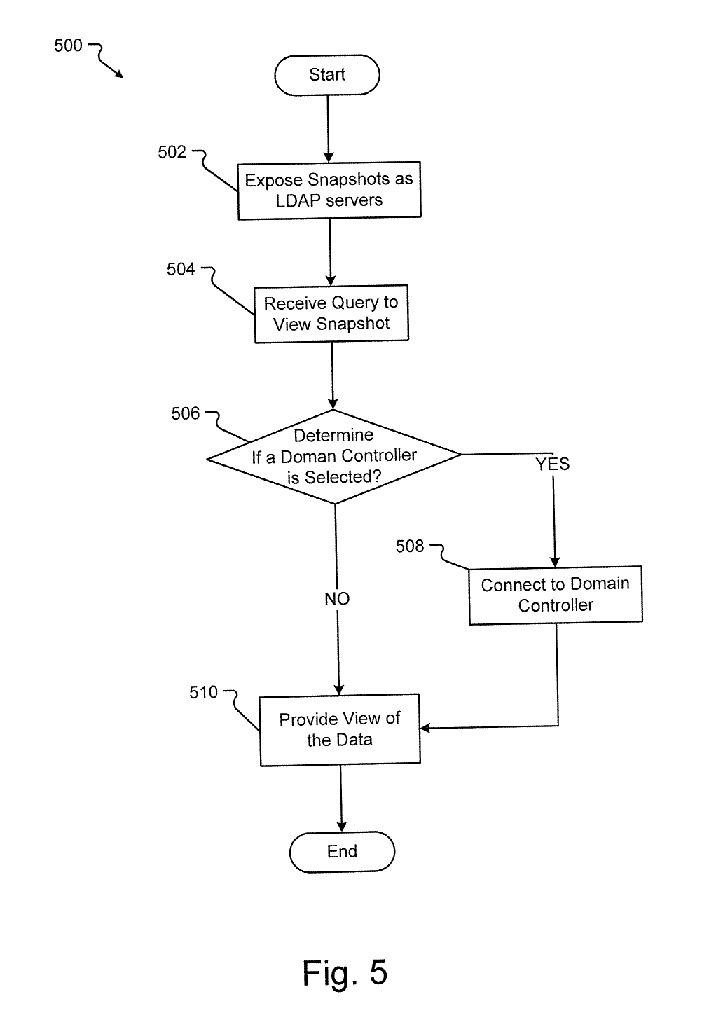

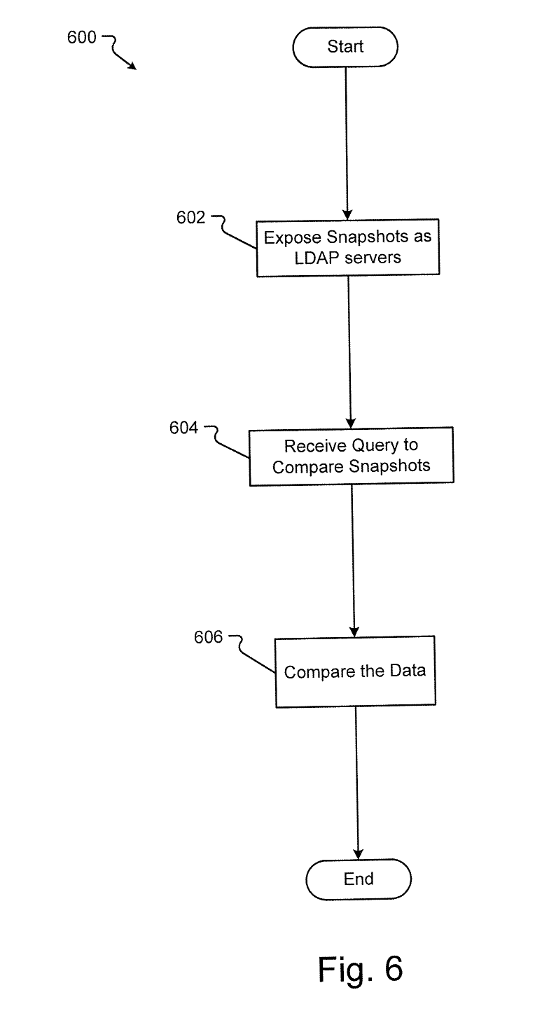

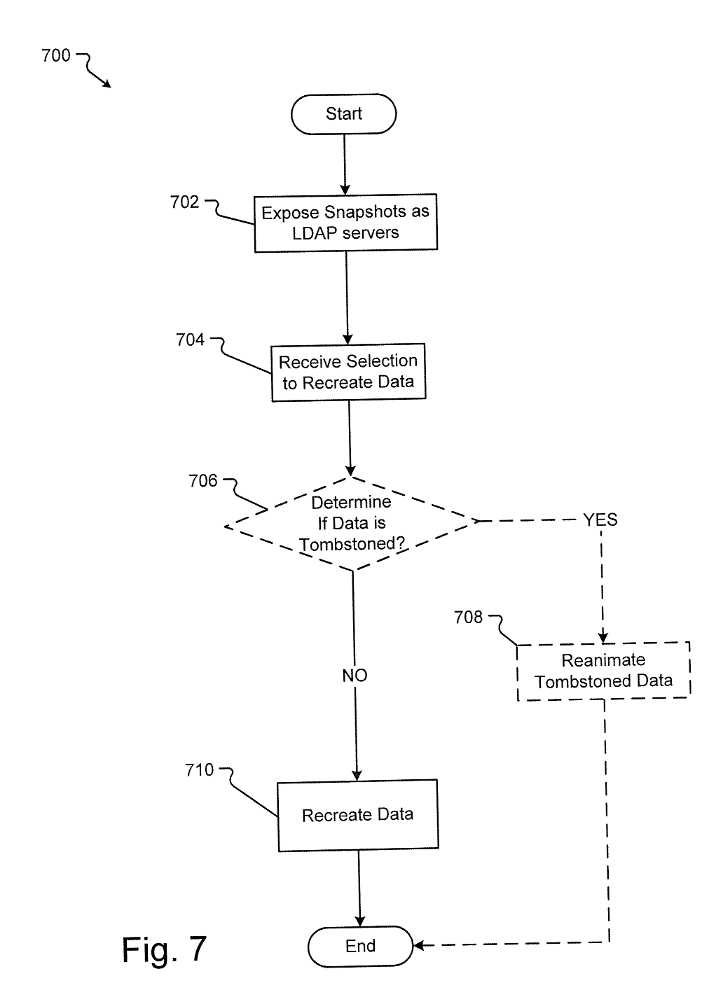

Another embodiment of a method 500 for providing snapshot data to a user is shown in FIG. 5. In embodiments, the method 500 is a set of computer instructions executed in a computer system. The method 500 generally starts with a “Start” operation and ends with an “End” operation. In embodiments, each snapshot maps to one database of a single Domain Controller. To view a snapshot, a user can connect to the LDAP server through the pre-specified port using a credential that is valid as confirmed by the Domain Controller (as of that point in time captured by the snapshot). This authentication process may be used whenever using snapshot data but will not be described in conjunction with FIGS. 6 or 7.

Expose operation 502 exposes the snapshots. In one embodiment, the snapshot is exposed as an LDAP server. A user, in embodiments, mounts a snapshot. In embodiments, the snapshot is then made available as or converted into database data. Tools available for directory service data are then available to access the snapshot data as exposed database data.

In one embodiment, a user discovers a snapshot to expose by entering and viewing information on a user interface 202 (FIG. 2) provided by a snapshot manager 214 (FIG. 2). The snapshots may be local at the user's client machine, such as Client 1 110 (FIG. 1), or remote at a server, such as Server 1 102 (FIG. 1). Upon determining a snapshot to expose, the user may mount the snapshot at a port. In embodiments, a snapshot browser 206 then exposes the snapshot as database data.

Receive operation 504 receives a query to view the snapshot data. In embodiments, a user requests a view of the data through a user interface 202 (FIG. 2). The snapshot browser 206 (FIG. 2) receives the request to view the snapshot data.

Determine operation 506 determines if a domain controller is selected. A domain controller, in embodiments, is a server that controls the directory structure for a domain or set of servers. Snapshots may exist locally or on remote servers. The remote servers may be domain controllers that control the directory structure for a forest or tree in the directory system. Thus, the snapshots at the domain controller may contain more information than the snapshot stored locally at the client machine. If one of the snapshots selected is at a domain controller, the process flows YES to connect operation 508. If none of the snapshots selected is at a domain controller, the process flows NO to provide operation 510.

Connect operation 508 connects with the domain controller. For example, if the user is viewing snapshots at Client 1 110 (FIG. 1), the snapshot browser 206 (FIG. 2) connects with the domain controller, Server 1 102 (FIG. 1). The snapshot browser 206 (FIG. 2) may use any means or system to communicate with the domain controller. The snapshot data at the domain controller is provided to the snapshot browser 206 (FIG. 2) for the view operation.

Provide operation 510 provides a view of the snapshot data. In embodiments, the snapshot browser 206 (FIG. 2) generates a database for the snapshot data. A view of the snapshot database data may be sent to the user interface 202 (FIG. 2) for display to the user. The snapshot browser 206 (FIG. 2), in embodiments, provides a view of the exposed snapshot data in a database form that is similar to the directory system data.

An embodiment of a method 600 for comparing snapshot data is shown in FIG. 6. In embodiments, the method 600 is a set of computer instructions executed in a computer system. The method 600 generally starts with a “Start” operation and ends with an “End” operation.

Expose operation 602 exposes the snapshot data as a database. In one embodiment, the snapshot is exposed as an LDAP server. Expose operation 602 is similar to or the same as expose operation 502 explained in conjunction with FIG. 5.

Receive operation 604 receives a query to compare snapshot data. In an embodiment, a user enters information associated with two snapshots into the user interface 202 (FIG. 2). For example, the user may enter a first snapshot 304 (FIG. 3) and a second snapshot 306 (FIG. 3). In embodiments, each snapshot may be mounted and exposed as an LDAP server by a snapshot manager 214 (FIG. 2). In alternative embodiments, more than two snapshots are exposed for comparison. Further, only a portion of snapshot data may be exposed in the two snapshots.

Receive operation 604 receives a query to compare the snapshot data. In embodiments, a user requests a comparison of the data for the two or more snapshots through a user interface 202 (FIG. 2). The snapshot browser 206 (FIG. 2) receives the request to compare the snapshot data.

Compare operation 606 compares the two or more snapshots input by the user. In an embodiment, the query processor 204 (FIG. 2) provides the two input snapshots to the snapshot browser 206 (FIG. 2), which compares the snapshots. For example, the snapshot browser 206 (FIG. 2) may determine if an object in a first snapshot exists in a second snapshot. The snapshot browser 206 (FIG. 2) may scan for an object ID, which exists in the first snapshot, in a second snapshot. In another example, the snapshot browser 206 (FIG. 2) determines how many objects exists in the first snapshot compared to the second snapshot. In still another example, the user may determine any new objects that were created between the creation of a first snapshot and a second snapshot. One skilled in the art will recognize other possible examples for how the snapshots may be compared. The compared data may be presented to the user in a user interface 202 (FIG. 2).

An embodiment of a method 700 for restoring data from a snapshot is shown in FIG. 7. In embodiments, the method 700 is a set of computer instructions executed in a computer system. The method 700 generally starts with a “Start” operation and ends with an “End” operation.

Expose operation 702 exposes the snapshot data as a database. In one embodiment, the snapshot is exposed as an LDAP server. Expose operation 702 is similar to or the same as expose operation 502 explained in conjunction with FIG. 5.

Receive operation 704 receives a query to restore data from the snapshot data. In an embodiment, a user enters information associated with a snapshot into the user interface 202 (FIG. 2). For example, the user may enter an object ID for an object in a snapshot 304 (FIG. 3). The object may have been deleted accidentally and needs to be restored. In embodiments, the snapshot may be mounted and exposed as an LDAP server by a snapshot manager 214 (FIG. 2).

In an embodiment, an optional determine operation 706 determines if the data to be restored is for a deleted object. In embodiments, if an object has been deleted within a predetermined amount of time, referred to as the tombstone lifetime, the deleted object is tombstoned. A tombstoned object is a directory object that has been deleted but has one or more system-protected attributes that are preserved in the directory. A tombstoned object may be reanimated. When a tombstoned object is reanimated, the object is placed back in the live directory with some system-protected attributes. However, other attributes of the object need to be repopulated or restored. If the object to be recovered is tombstoned, the process flows YES to reanimate operation 708. If the object to be restored is not tombstoned, the process flows NO to recreate operation 710.

In embodiments, optional reanimate operation 708 reanimates the tombstoned object. In embodiments, the snapshot browser 206 (FIG. 2) provides the user with a view into the attributes of one or more objects in the snapshot data. The user may select one or more attributes in the snapshot data to restore attributes into the reanimated object. In embodiments, the user may copy the values for the attributes from the snapshot data. The user may then repopulate the attributes in the reanimated object with the attribute values copied from the snapshot. As such, the object is recovered.

Recreate operation 710 recreates data from the snapshot. In embodiments, the snapshot browser 206 (FIG. 2) provides information to an LDAP server. The LDAP server copies the object or data and places the object or data in the active directory system. Thus, the object is restored as the object existed at the time the snapshot was created.

With reference to FIG. 8, an embodiment of a computing environment for implementing the embodiments described herein is shown. In one embodiment, the system 200 (FIG. 2) is a software application executed at a client machine. In alternative embodiments, the system 200 (FIG. 2) is a server, desktop, laptop, handheld device, or other computing system executing software for the client. Embodiments of the computer environment for the system 200 (FIG. 2) include a computer system, such as computer system 800.

In its most basic configuration, computer system 800 typically includes at least one processing unit 802 and system memory 804. In embodiments, the system 200 (FIG. 2) is loaded into and run by the processing unit 802 from system memory 804 of a computer. Depending on the exact configuration and type of computer system 800, memory 804 may be volatile (such as RAM), non-volatile (such as ROM, flash memory, etc.), or some combination of the two. This most basic configuration of the computer system 800 is illustrated in FIG. 8 by dashed line 806.

Additionally, device 800 may also have additional features/functionality. For example, device 800 includes additional storage (removable and/or non-removable) including, but not limited to, magnetic, optical disks or tape. Such additional storage is illustrated in FIG. 8 by removable storage 808 and non-removable storage 810. In embodiments, the system 200 (FIG. 2), or other component described herein, is stored in non-removable storage 810, although the software components to be installed or data may be saved into removable storage 808, and loaded into system memory 804 for use by or for execution by the processing unit 802 on the computer. In some embodiments, the snapshot browser 206 (FIG. 2), the snapshot datastore 210 (FIG. 2), or other software components described herein, are one of several components of a software system 200 (FIG. 2). Computer storage media includes volatile and nonvolatile, removable and non-removable media implemented in any method or technology for storage of information such as computer readable instructions, data structures, program modules, or other data.

Memory 804, removable storage 808, and non-removable storage 810 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage, other magnetic storage devices, or any other medium which is used to store the desired information, for example, the snapshots 304 and 306 (FIG. 3), and which is accessed by device 800 and processor 802 on the client computer or the server computer. Any such computer storage media may be part of device 800. In embodiments, the snapshots 304 and 306 (FIG. 3) may be stored locally at the client computer. In other embodiments, the snapshots 304 and 306 (FIG. 3) may be stored at a remote server. For example, in Active Directory databases, one server functions in the role as domain controller. This server may store the snapshots 304 and 306 (FIG. 3) and transfer the snapshots 304 and 306 (FIG. 3) to the client being used to view the snapshot data.

Device 800 may also contain communications connection(s) 812 that allow the device to communicate with other devices. In embodiments, the communication connections 812 are used to send and/or receive data, for example, the snapshots 304 and 306 (FIG. 3), over a network, such as the Internet. Communications connection(s) 812 is an example of communication media.

In embodiments, device 800 includes a graphical user interface that includes input devices 814 and output devices 816. Data selections for the snapshots through the user interface 202 (FIG. 2), in embodiments, are selected with user input device(s) 814, and the data are displayed with output device(s) 816. Input device(s) 814 are also referred to as user interface selection devices and include, but are not limited to, a keyboard, a mouse, a pen, a voice input device, a touch input device, etc. Output device(s) 816 are also referred to as displays and include, but are not limited to, cathode ray tube displays, plasma screen displays, liquid crystal screen displays, speakers, printers, etc. These devices, either individually or in combination, form the graphical user interface 202 (FIG. 2) used to display snapshot data as described herein. All these devices are well know in the art and need not be discussed at length here.

Computer system 800 typically includes at least some form of computer readable media. Computer readable media can be any available media that can be accessed by processing unit 802. By way of example, and not limitation, computer readable media comprise computer storage media. Software system 200 (FIG. 2) and the components, methods, and/or algorithms described herein comprise such modules or instructions executable by computer system 800 that may be stored on computer storage medium. Computer storage media includes volatile and nonvolatile, removable and non-removable media implemented in any method or technology for storage of information such as computer readable instructions, data structures, program modules, or other data. Combinations of the any of the above should also be included within the scope of computer readable media.

Although the embodiments have been described in language specific to structural features, methodological acts, and computer-readable media containing such acts, it is to be understood that the possible embodiments, as defined in the appended claims, are not necessarily limited to the specific structure, acts, or media described. One skilled in the art will recognize other embodiments or improvements that are within the scope and spirit of the present invention. Therefore, the specific structure, acts, or media are disclosed only as illustrative embodiments. The invention is defined by the appended claims.

What is claimed is:

1. A method executable in a computer system for manipulating snapshot data on an online server, the method comprising:
receiving a request for snapshot data;
determining a type of action requested to be performed on the snapshot data;
if the type of action is to view the snapshot data, viewing the snapshot data;
if the type of action is to compare the snapshot data, comparing the snapshot data; and
if the type of action is to restore the snapshot data, restoring the snapshot data.

2. The method as defined in claim 1, wherein viewing the snapshot data comprises:
exposing the snapshot data;
receiving a query to view the exposed snapshot data; and
providing a view of the snapshot data.

3. The method as defined in claim 2, further comprising:
determining if the requested snapshot data is located at a domain controller;
connecting to the domain controller to retrieve the snapshot data; and
authenticating a user to connect to the domain controller.

4. The method as defined in claim 2, wherein the snapshot data is exposed as an LDAP server.

5. The method as defined in claim 1, wherein comparing the snapshot data comprises:
exposing the snapshot data;
receiving a query to compare the exposed snapshot data; and
comparing the snapshot data.

6. The method as defined in claim 5, wherein two or more snapshots are compared.

7. The method as defined in claim 1, wherein restoring the snapshot data comprises:
exposing the snapshot data;
receiving a query to restore the exposed snapshot data; and
recreating the snapshot data.

8. The method as defined in claim 1, wherein restoring the snapshot data comprises:
exposing the snapshot data;
receiving a query to restore the exposed snapshot data;
reanimating tombstoned data; and
repopulating data sourcing from the snapshot data.

9. The method as defined in claim 8, further comprising:
determining if an object in the snapshot data is tombstoned;
if the object is tombstoned, reanimating the object and repopulating unpreserved attributes to the object based on snapshot data; and
if the object is not tombstoned, restoring object from the snapshot data.

10. The method as defined in claim 1, wherein the snapshot data comprises two or more snapshots.

11. The method as defined in claim 1, wherein the snapshot data comprises a portion of a snapshot.

12. A computer storage medium having computer-executable components stored thereon, the computer executable components executable in a computer system for manipulating snapshot data, the components comprising:
a user interface, the user interface receiving selections for snapshot data from a user and displaying snapshot data to the user;
a snapshot browser in communication with the user interface, the snapshot browser exposing snapshot data; and
a query processor in communication with the user interface and the snapshot browser, the query processor receiving a request from the user interface to manipulate snapshot data, the query processor, in response to the received request, manipulating snapshot data exposed by the snapshot browser.

13. The components as defined in claim 12, further comprising:
a snapshot manager in communication with the user interface, the snapshot manager providing discovery of one or more snapshots to the user, wherein the snapshot manager enumerates a set of snapshots from a domain controller and retrieves snapshot location information for each of the snapshots; and
a snapshot datastore in communication with the snapshot manager, the snapshot datastore storing snapshot data, wherein the snapshot location information identifies the location of the snapshot data.

14. The method as defined in claim 12, wherein the snapshot browser exposes the snapshot data as a database.

15. The method as defined in claim 14, wherein the snapshot data is exposed as a LDAP server.

16. A computer storage medium having computer-executable instructions stored thereon, the computer executable instructions comprising a method executable in a computer system for manipulating snapshot data, the method comprising:
providing discovery of one or more snapshots;
mounting one or more snapshots;
exposing one or more snapshots as an LDAP server;
receiving one or more action requests to manipulate the exposed snapshot data;
determining a type of action requested;
in response to the action request, manipulating the exposed snapshot data; and
providing the manipulated snapshot data.

17. The method as defined in claim 16, wherein two or more snapshots are exposed, wherein the type of action is determined to be a comparison, and wherein manipulating the exposed snapshot data comprises:
comparing a first snapshot with a second snapshot; and
generating a comparison of the first snapshot with the second snapshot.

18. The method as defined in claim 16, wherein the type of action is determined to be a view of the data, and wherein manipulating the exposed snapshot data comprises providing a view of the snapshot data as a database.

19. The method as defined in claim 16, wherein the type of action is determined to be a restoration of the data, and wherein manipulating the exposed snapshot data comprises:
determining if the exposed snapshot data was tombstoned;
if the exposed snapshot data was tombstoned, reanimating the tombstoned snapshot data; and
if the exposed snapshot data was not tombstoned, recreating the snapshot data in a directory system.

20. The method as defined in claim 16, wherein the providing discovery of one or more snapshots comprises:
connecting to a domain controller which stores a set of snapshots;
enumerating the set of snapshots; and
retrieving snapshot location information for each of the snapshots.
